(19) United States
(12) Patent Application Publication
(10) Pub. No.: US 2009/0090035 A1
(43) Pub. Date: Apr. 9, 2009

(54) Display

(76) Inventor: Patrick William Murray, Scituate, MA (US)

Correspondence Address: O''Brien Jones, PLLC (w/iRobot Corp.), 8200 Greensboro Drive, Suite 1020A, McLean, VA, 22102, US

(21) Appl. No.: 11/905,989

(22) Filed: Oct. 5, 2007

(51) Int. Cl. G09F 1/08; G09F 5/00; A47F 3/00

(52) U.S. Cl. 40/539; 186/52

(57) ABSTRACT

A display has a shape similar to at least a base of an upright vacuum cleaner. The display comprises a base configured to rest on a support surface, a curved section extending upward from the base, and a mounting area on or extending above the curved section. The mounting area is configured to have a product mounted thereon. Alternatively, a generally vertical column extends, upward from the base and a mounting/information area is mounted on or integral with the generally vertical column. The mounting/information area is configured to have a product mounted thereon.

### FIELD

The present invention relates generally to a display, and more particularly to a display having a size and shape that is similar to at least the base of an upright vacuum cleaner.

### INTRODUCTION

Cleaning, sweeping, and washing robots, for example, have a compact size. While this can be beneficial for the product functionally, it can be less beneficial for product display purposes. In a typical sales environment, other vacuums such as upright and canister vacuums have a larger size and extend up closer to a consumer's eye level, and are therefore more likely to be noticed and purchased by a consumer.

An upright vacuum cleaner can be defined as a vacuum that stands upright without support and has a handle that may rise to about waist height.

### SUMMARY

The present invention may address one or more of the above-mentioned issues. Other features and/or advantages may become apparent from the description which follows.

The present invention provides a display having a shape similar to at least a base of an upright vacuum cleaner. The display comprises a base configured to rest on a support surface, a curved section extending upward from the base, and a mounting area on or extending above the curved section. The mounting area is configured to have a product mounted thereon.

The present invention also provides a display having a shape similar to at least a base of an upright vacuum cleaner. The display comprises a generally vertical column extending upward from the base and a mounting/information area is mounted on or integral with the generally vertical column. The mounting/information area is configured to have a product mounted thereon.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

At least some features and advantages of the claimed subject matter will be apparent from the following detailed description of embodiments consistent therewith, which description should be considered with reference to the accompanying drawings, wherein:

FIG. 1 illustrates left and right perspective views of an exemplary embodiment of a display in accordance with the teachings of the present invention;

FIG. 2 illustrates a front view of the exemplary embodiment of FIG. 1;

FIG. 3 also illustrates a front view of the exemplary embodiment of FIG. 1;

FIG. 4 also illustrates a front view of the exemplary embodiment of FIG. 1;

FIG. 5 also illustrates a front view of the exemplary embodiment of FIG. 1;

FIG. 6 illustrates a right perspective view of the exemplary embodiment of FIG. 1;

FIG. 7 illustrates a right perspective view of another exemplary embodiment of the present teachings;

FIG. 8 also illustrates a right perspective view of the exemplary embodiment of FIG. 7;

FIG. 9 illustrates a front view of another exemplary embodiment of the present teachings;

FIG. 10 illustrates a right perspective view of the exemplary embodiment of FIG. 9;

FIG. 11 illustrates left and right perspective views of the exemplary embodiment of FIG. 9;

FIG. 12 illustrates a right perspective view of the exemplary embodiment of FIG. 9;

FIG. 13 illustrates a left perspective view of the exemplary embodiment of FIG. 9;

FIG. 14 illustrates a perspective view of the exemplary embodiment of FIG. 7;

FIG. 15 illustrates a front view of the exemplary embodiment of FIG. 7;

FIG. 16 illustrates a rear view of the exemplary embodiment of FIG. 7;

FIG. 17 illustrates a right side view of the exemplary embodiment of FIG. 7;

FIG. 18 illustrates a left side view of the exemplary embodiment of FIG. 7;

FIG. 19 illustrates a top view of the exemplary embodiment of FIG. 7;

FIG. 20 illustrates a bottom view of the exemplary embodiment of FIG. 7;

FIG. 21 illustrates a perspective view of the exemplary embodiment of FIG. 1;

FIG. 22 illustrates a front view of the exemplary embodiment of FIG. 1;

FIG. 23 illustrates a rear view of the exemplary embodiment of FIG. 1;

FIG. 24 illustrates a right side view of the exemplary embodiment of FIG. 1;

FIG. 25 illustrates a left side-view of the exemplary embodiment of FIG. 1;

FIG. 26 illustrates a top view of the exemplary embodiment of FIG. 1;

FIG. 27 illustrates a bottom view of the exemplary embodiment of FIG. 1;

FIG. 28 illustrates a perspective view of the exemplary embodiment of FIG. 9;

FIG. 29 illustrates a front view of the exemplary embodiment of FIG. 9;

FIG. 30 illustrates a rear view of the exemplary embodiment of FIG. 9;

FIG. 31 illustrates a right side view of the exemplary embodiment of FIG. 9;

FIG. 32 illustrates a left side view of the exemplary embodiment of FIG. 9;

FIG. 33 illustrates a top view of the exemplary embodiment of FIG. 9;

FIG. 34 illustrates a bottom view of the exemplary embodiment of FIG. 9;

FIG. 35 illustrates a side view of the exemplary embodiment of FIG. 1; and

FIG. 36 illustrates a bottom view of the exemplary embodiment of FIG. 1.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION OF VARIOUS EXEMPLARY EMBODIMENTS

Reference will now be made to various embodiments, examples of which are illustrated in the accompanying drawings. The various exemplary embodiments are not intended to limit the disclosure. To the contrary, the disclosure is intended to cover alternatives, modifications, and equivalents.

Various exemplary embodiments of the present teachings contemplate a display that allows products other than upright vacuums, such as cleaning, sweeping, and washing robots, and vacuum accessories, to be displayed in the same manner and space as upright vacuums. Such cleaning, sweeping, and washing robots can include, for example, a robotic vacuum cleaner such as the Roomba® manufactured by iRobot®. In various exemplary embodiments, the display can generally mimic the shape of at least some upright vacuum cleaners. Such a shape provides stability to an upright vacuum and can similarly provide stability for an upright display, while allowing the display and its contents to homogenously fit in or near a display of upright vacuums. Further, the height of the display can place displayed products closer to consumer eye levels.

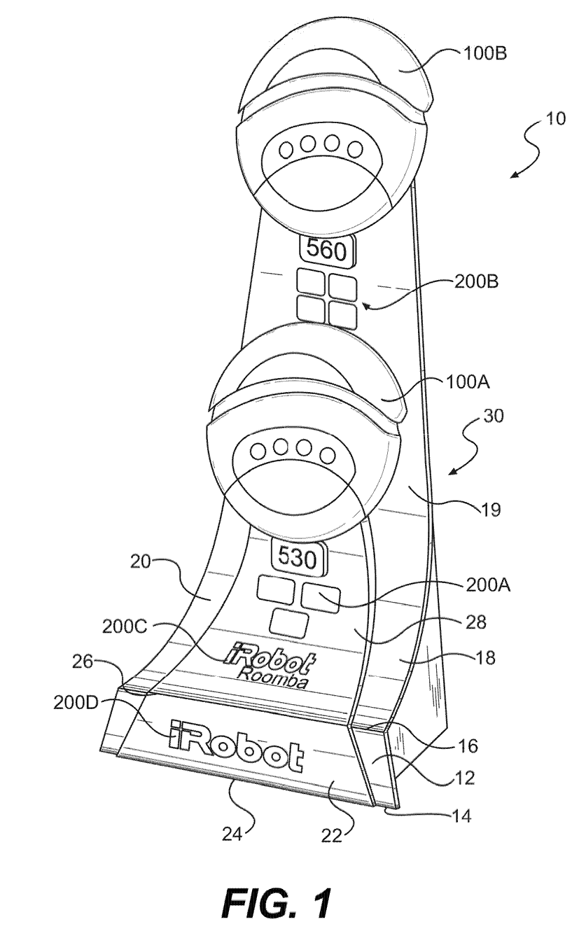

FIG. 1 illustrates left and right perspective views of an exemplary embodiment of a display in accordance with the teachings of the present invention. As can be seen, the display 10 can mimic the general shape of some upright vacuum cleaners. A bottom section 12 of the illustrated exemplary embodiment may have a generally trapezoidal shape extending from an edge 14 where it touches a floor or other supporting surface to an edge 16 vertically spaced therefrom. From the edge 16, the display can extend in a curved manner through a curved section 18 that decreases in width as it extends upwardly. Such a curved section 18 may also mimic a general shape of some upright vacuum cleaners. A non-curved section 20 may extend upward from the curved section 18 and may decrease in width as it extends upwardly to a top edge that may be obscured by a displayed product.

In the illustrated exemplary embodiment, two products 100A and 100B are mounted on the display 10 in a vertically spaced manner. The products can be mounted on the non-curved section 20 of the display 10, as a flat surface may be a more suitable mounting surface for many products. Various embodiments of the present teachings contemplate different product mounting configurations. For example, any number of products may be mounted on the display, depending on the dimensions of the display and the size of the products. One product or a single type of product could be mounted any number of times on a single display. The products need not be aligned when mounted vertically as shown, but instead can optionally be staggered. Indeed, the products can be mounted so that they are displayed in a row, can be displayed in a number of rows spaced vertically, or can be randomly mounted. One skilled in the art will appreciate the large variety of mounting configurations on a display constructed in accordance with the present teachings.

In the illustrated exemplary embodiment, an optional raised layer 20 is added to the display 10. The raised layer 20 can sit overtop of the bottom section 12, the edge 16, and the curved section 18 of the display 10. A bottom section 22 of the optional raised layer 20 can have a generally trapezoidal shape complimenting the generally trapezoidal shape of the bottom section 12 and can extend from an edge 24 where it touches a floor or other supporting surface to an edge 26 vertically spaced therefrom. From the edge 26, the display can extend in a curved manner through a raised curved section 28 that decreases in width as it extends upwardly. The raised curved section 28 can have a curvature that is the same or greater than the curvature of the curved section 18 that extends underneath it. The width of the raised curved section 28 can decrease to the same degree as the curved section 18 that extends underneath it, or can decrease to a greater or lesser extent.

Various embodiments of the present teachings, such as the exemplary embodiment illustrated in FIG. 1, contemplate the placement of information, including advertising, at least in areas of the display that remain visible when products are mounted on the display. For example, in the exemplary embodiment of FIG. 1, advertising information is included at 200A, 200B, 200C, and 200D. The advertising information can be arranged on the display to be associated with a product, for example adjacent a product. In the exemplary embodiment of FIG. 1, advertising information is provided at location 200A that is relevant to, product 100A, and advertising information is provided at location 200A that is relevant to product 100B. Other advertising information on the exemplary embodiment of FIG. 1 includes the manufacturer's brand name at 200C and 200D, and a description of the type of product being displayed at 200C. If no raised portion 20 is included, information included at 200C and 200D could instead be provided on portions 12 and 18 of the display.

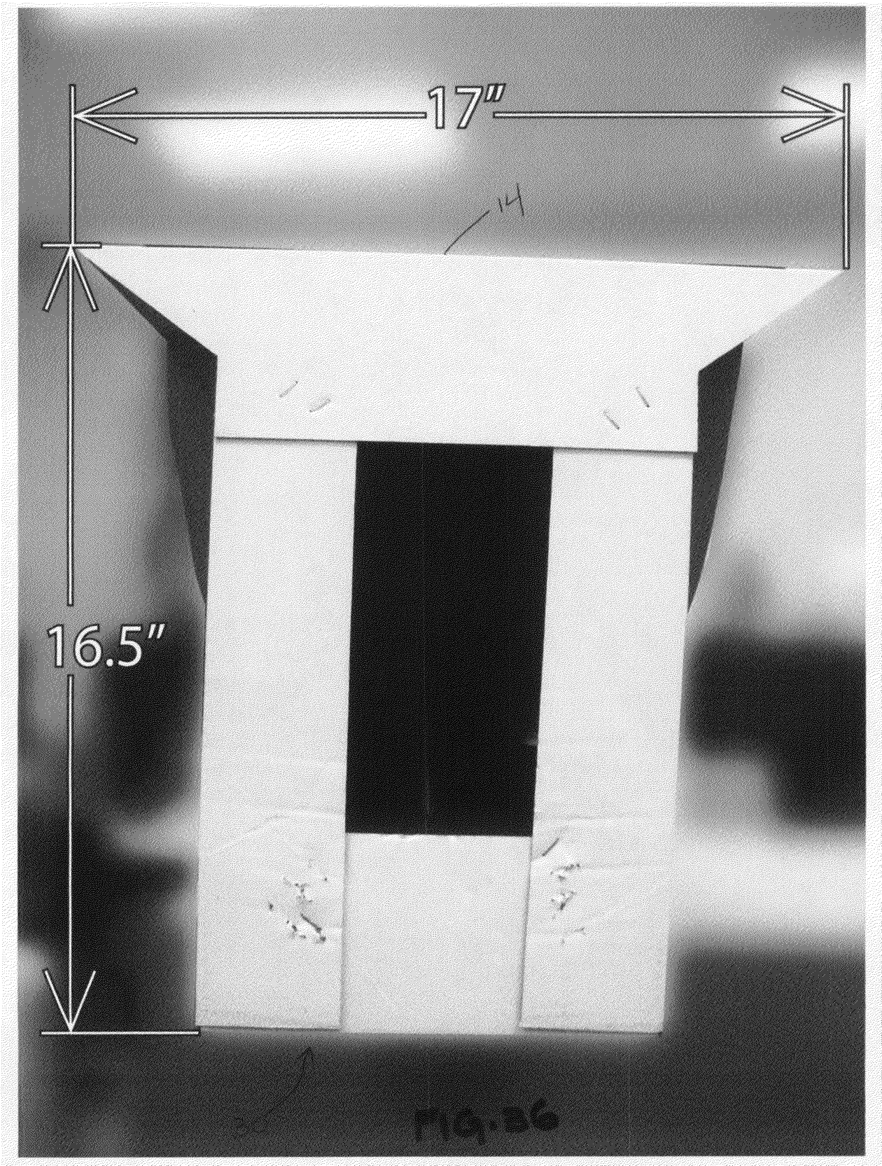

The rest of the supporting structure of the display, illustrated generally in FIG. 1 at 30, includes any known and typical rear support structure for upright displays, such as the exemplary implementation illustrated in FIGS. 35 and 36.

In various embodiments of the present teachings, the dimensions of the display can be similar to those of an average upright vacuum cleaner and/or can be such that at least one product or graphical representation is placed at consumer eye level. In one exemplary implementation of a display as shown in FIG. 35, the overall height of the display can be about 41 inches without a mounted product, and about 43.5 inches to the top of a mounted robotic vacuum cleaner. In an exemplary implementation of a display in FIG. 36, the overall width of the display base at its widest (edge 14 in FIG. 1) can be about 17 inches and the thickness of the rear support area 30 can be about 16.5 inches. One skilled in the art will appreciate that the dimensions set forth above can vary.

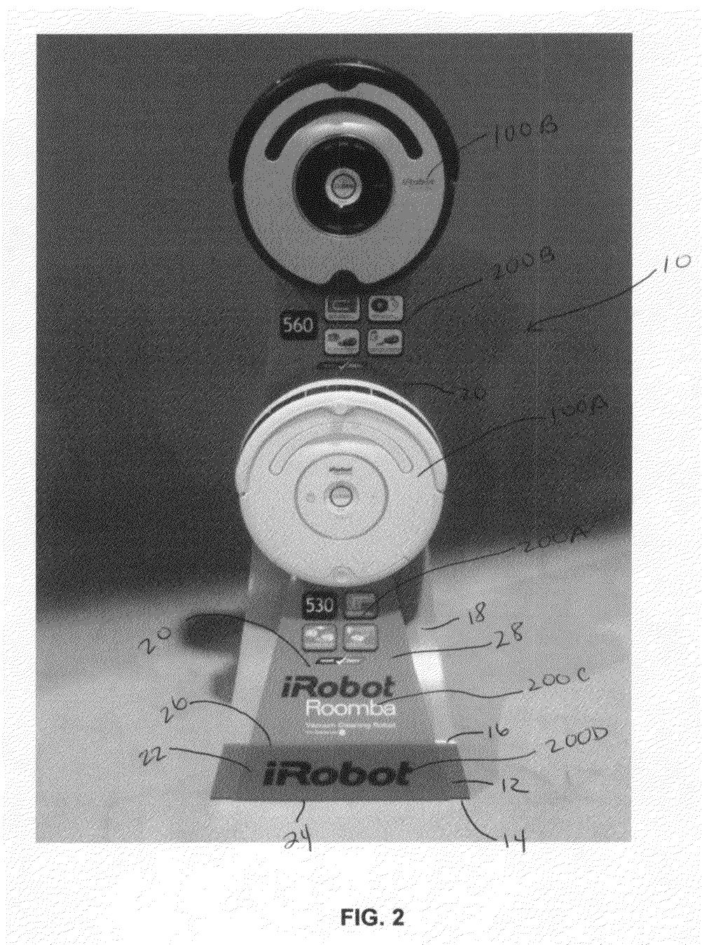

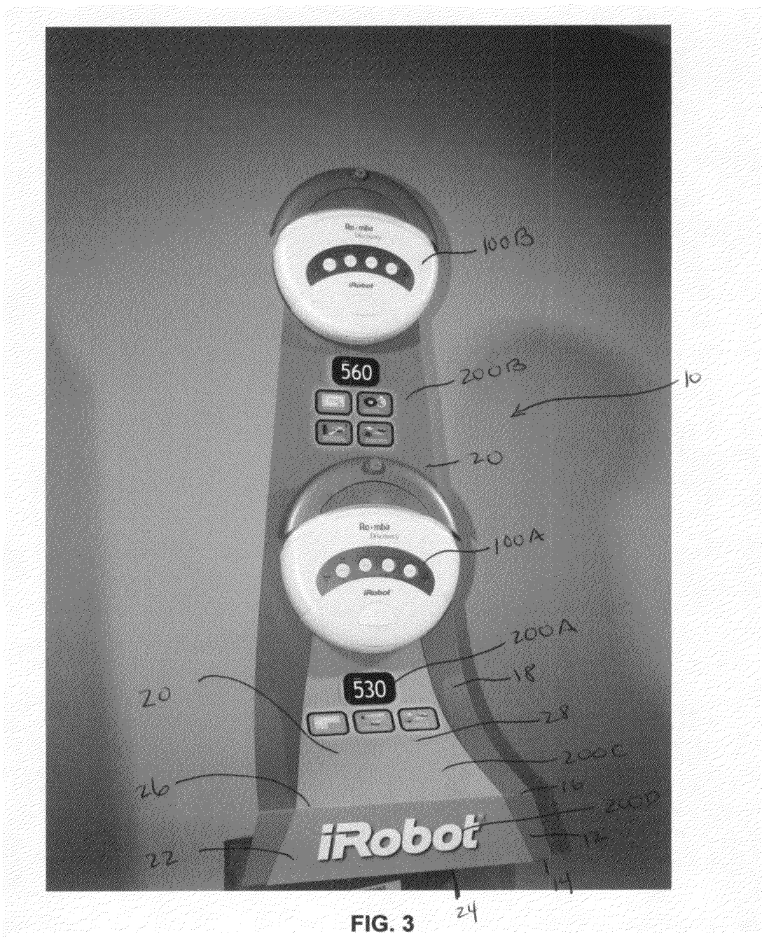

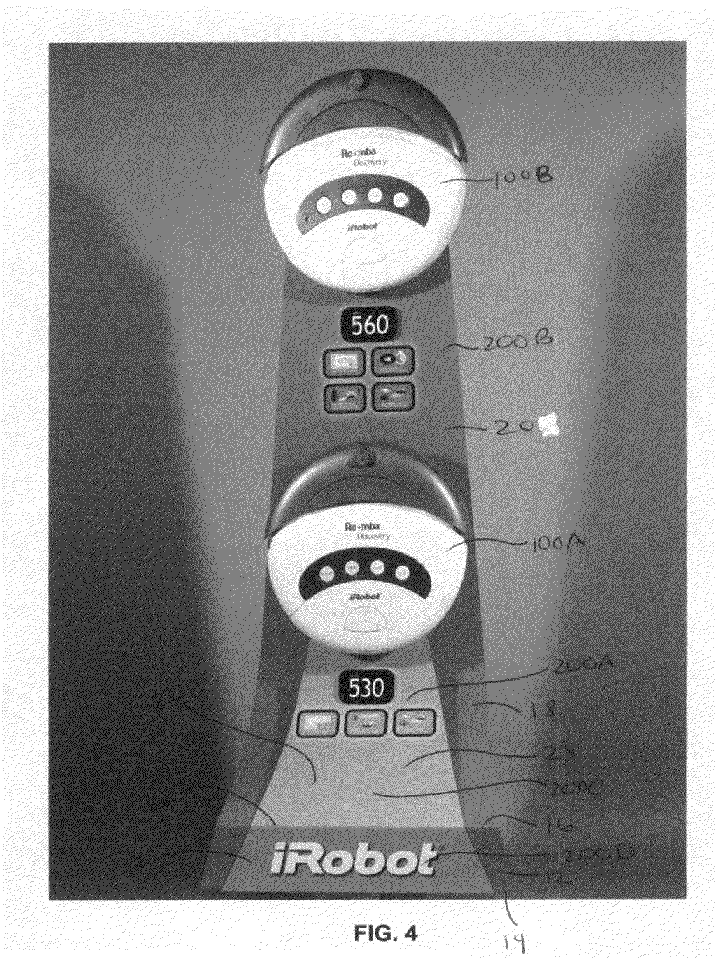

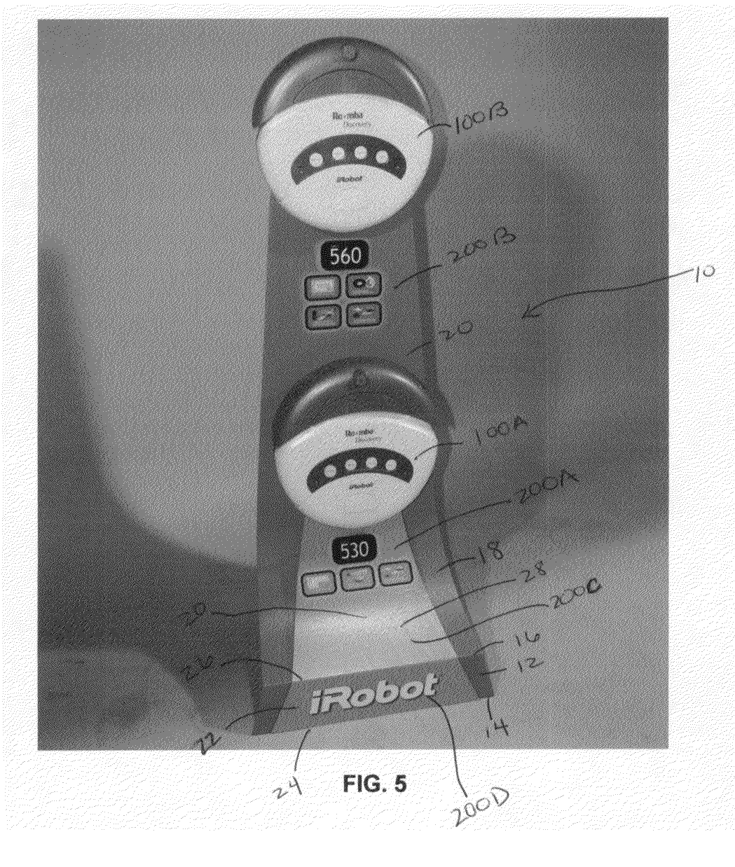

FIG. 2 is a front view of the exemplary embodiment of FIG. 1, having only a variation in the arrangement of information provided on the display 10 at locations 200A and 200B. FIGS. 3-6 illustrate front and right perspective views of the embodiment of FIG. 1, having only a variation in the arrangement of information provided on the display 10 at locations 200A and 200B, and having no information provided at location 200C.

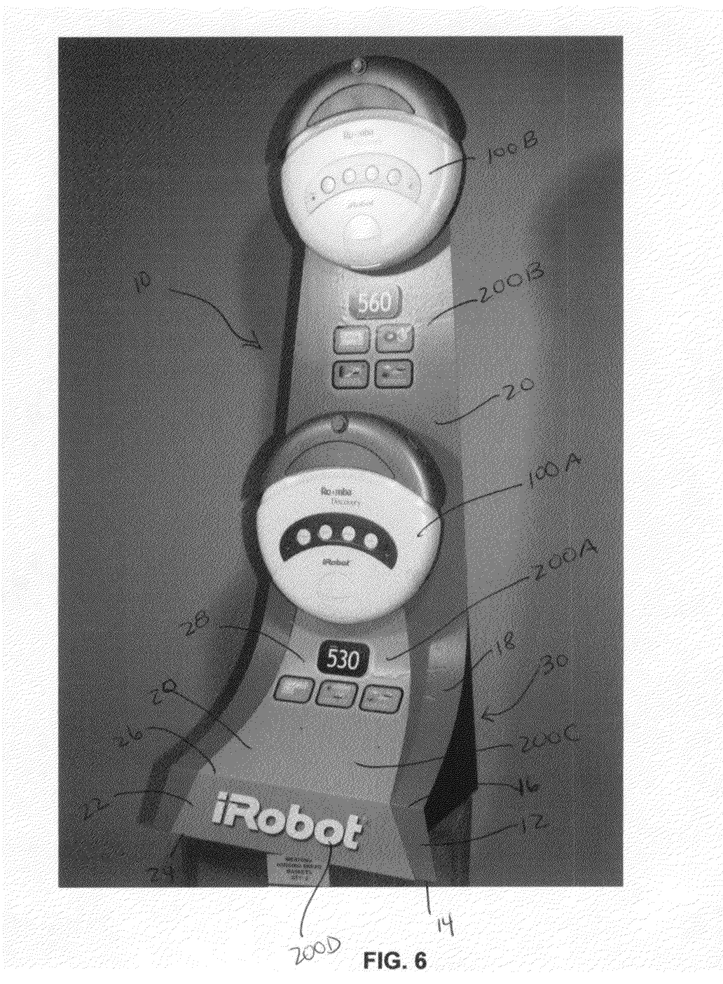

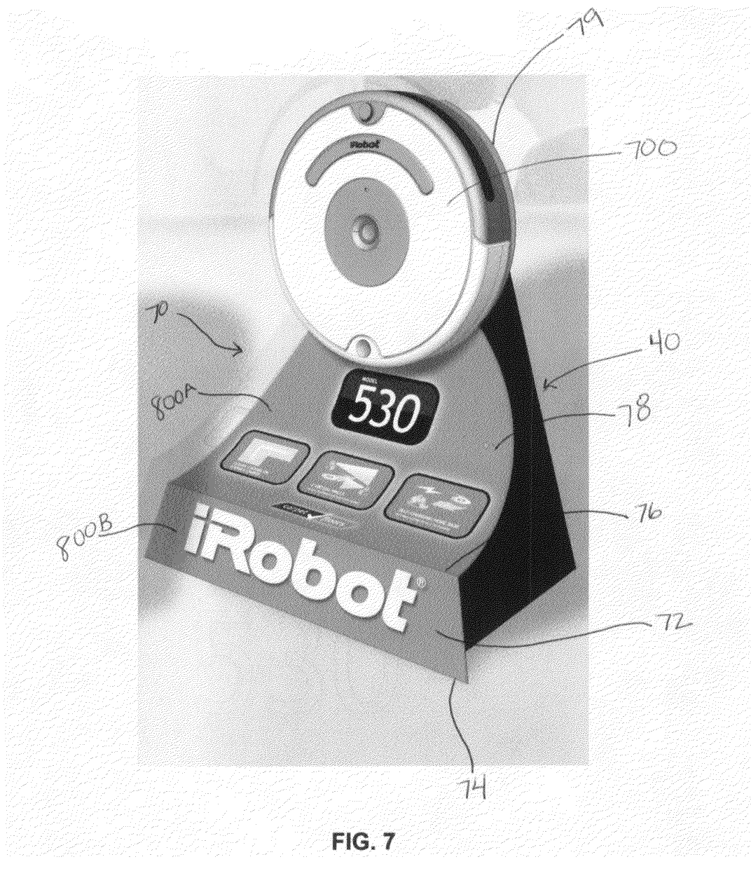

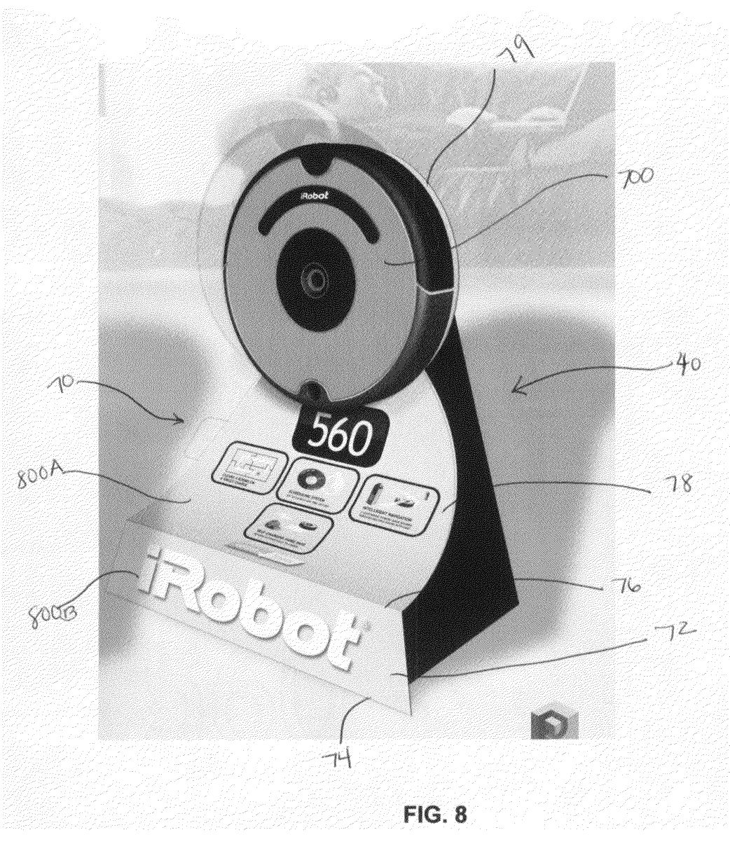

FIGS. 7 and 8 illustrate right perspective views of another exemplary embodiment of the present teachings. As can be seen, the display 70 can mimic the general shape of the bottom section of an upright vacuum cleaner. Such an embodiment can be used, for example, for products being displayed on a raised platform rather than on the floor. A bottom section 72 of the illustrated exemplary embodiment can have a generally trapezoidal shape extending from an edge 74 where it touches a supporting surface to an edge 76 vertically spaced therefrom. From the edge 76, the display can extend in a curved manner through a curved section 78 that can decrease in width as it extends upwardly. Such a curved section 78 can also mimic a general shape of a bottom section of some upright vacuum cleaners.

In various exemplary embodiments of the invention, the product can be mounted on a section of the display 70 having a complimentary size and shape, such as section 79 in FIGS. 7 and 8. In various exemplary embodiments, the mounting section 79 can be flat to facilitate better mounting of the product. The display having a complimentary-sized and -shaped mounting section 79 can be advantageous in that it may allow for better support for the product and can contain a graphical rendering of the product should the product be removed from the display. The graphical rendering of the product can be applied to the display itself. Application can include, for example, being part of the design as originally applied to the display such as by printing or laminating. It can additionally include, for example, printing or laminating over the original design. Alternatively, the graphical rendering can be a removable/interchangeable graphical rendering to be mounted or otherwise adhered to the display in any known way when a product is not mounted on the display. One skilled in the art would appreciate that such a complimentary-sized mounting area under the product (and a fixed or removable/interchangeable graphical rendering) could be available on all of the exemplary embodiments discussed herein.

In the illustrated exemplary embodiment, a product 700 is mounted on the display 70. Similar to the embodiment of FIGS. 1-6, the present teachings contemplate different product mounting configurations. For example, any number of products may be mounted on the display, in any suitable arrangement, depending on the dimensions of the display and the size of the products. One skilled in the art will appreciate the large variety of mounting configurations on a display constructed in accordance with the present teachings.

Although not illustrated, the exemplary embodiment illustrated in FIGS. 7 and 8 could additionally include a raised layer (not shown) similar to raised layer 20 in FIGS. 1-6. The raised layer could sit overtop of the bottom section 72, the edge 76, and at least a portion of the curved section 78 of the display 70. A bottom section of the raised layer could have a generally trapezoidal-shape complimenting the generally trapezoidal shape of the bottom section 72. A curved section of the raised layer could have a curvature that is the same or greater than the curvature of the curved section 78 that would extend underneath it. The width of the curved section could decrease to the same degree as the curved section 78 that would extend underneath it, or can decrease to a greater or lesser extent.

Various embodiments of the present teachings, such as the exemplary embodiment illustrated in FIGS. 7 and 8, contemplate the placement of information, including advertising, at least in areas of the display that remain visible when products are mounted on the display. For example, in the exemplary embodiment of FIGS. 7 and 8, advertising information is included at 800A and 800B. The advertising information can be arranged on the display to be associated with a product, for example adjacent a product. In the exemplary embodiments of FIGS. 7 and 8, advertising information is provided at location 800A that is relevant to product 700. Other advertising information on the exemplary embodiment of FIGS. 7 and 8 includes the manufacturer's brand name at 800B.

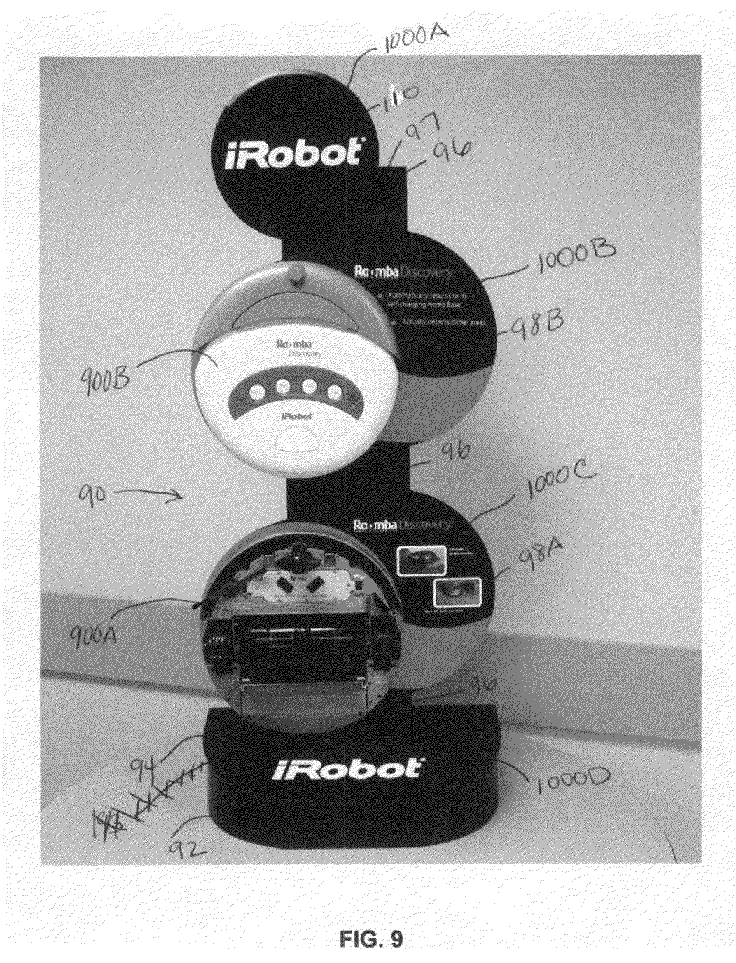

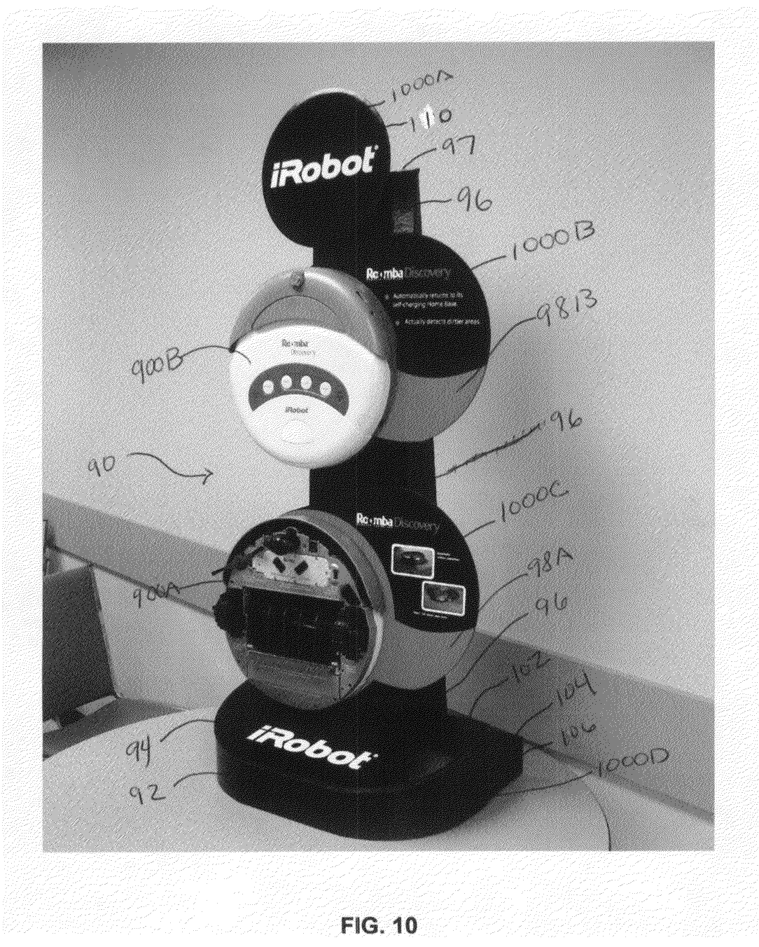

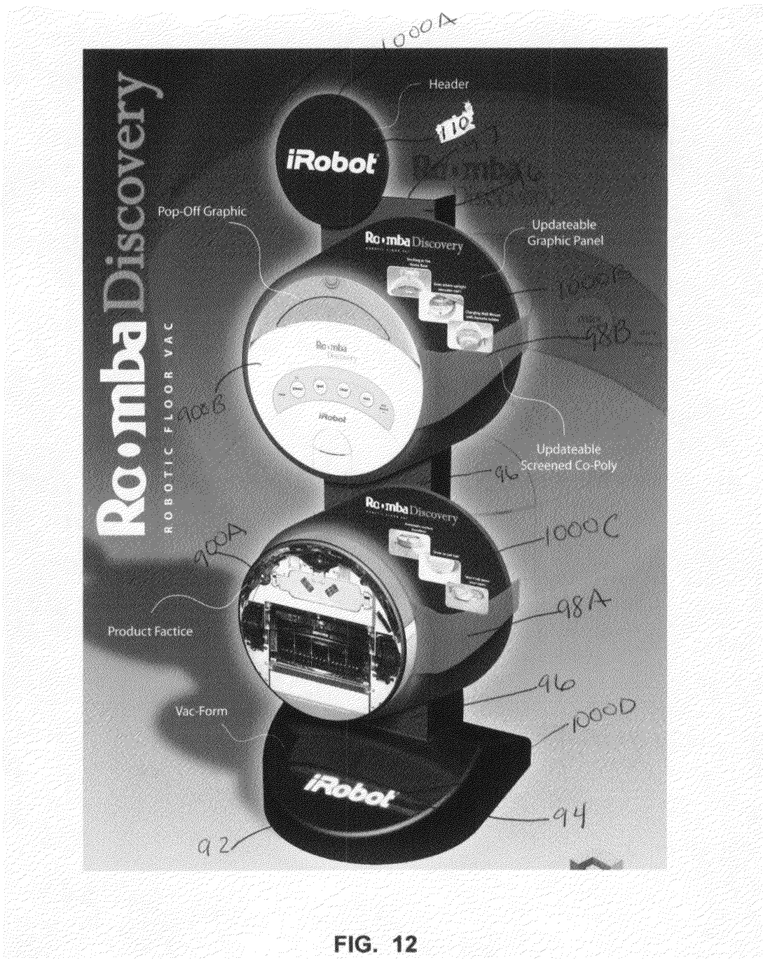

FIGS. 9-13 illustrate various views of another exemplary embodiment of the present teachings. As can be seen, a base of the display 90 can mimic the general shape of an upright vacuum cleaner base. A generally vertical wall 92 that wraps around at least the front and sides of the base of the illustrated-exemplary embodiment can extend from a floor or other supporting surface to meet an inclined surface 94. As can be seen in FIG. 10, the inclined surface 94 can extend upwardly to a peak 102, being followed by generally vertical wall 92. In some exemplary embodiments of the present teachings, the base of the display 90 can extend downwardly from the peak 94 toward a rear section 104 to a rear edge 106. In other exemplary embodiments, the inclined surface can extend through the rear section to the rear edge, such that the based is inclined from front to rear without a peak. In other embodiments of the present teachings, the base of the display 90 can extend generally horizontally from the peak 94 to a rear edge.

In the illustrated exemplary embodiment of FIGS. 9-13, a generally vertical column 96 extends upwardly from the base 90 to a top edge 97. The column 96 can vary in cross sectional shape and size, e.g., the width from its left side to its right side and a thickness from its front to its rear. In addition, the cross sectional size of the column 96 can vary within the same display 90, for example tapering in width and/or in thickness toward a top of the display 90.

In the illustrated exemplary embodiment of FIGS. 9-13, mounted on the column 96 or integral with the column 96 are two generally oval mounting/information areas 98A and 98B, which can be spaced vertically. Two products 900A and 900B can be mounted on the mounting/information areas 98A and 98B, respectively. Various embodiments of the present teachings contemplate different product mounting configurations. For example, any number of products may be mounted on each mounting information area, depending on the size of the mounting/information areas and the size of the products. Indeed, the present invention also contemplates any number of mounting/information areas; and the mounting/information areas need not be aligned when mounted vertically as shown, but instead can be staggered. One skilled in the art will appreciate the large variety of mounting configurations on a display constructed in accordance with the present teachings.

Various embodiments of the present teachings, such as the exemplary embodiment illustrated in FIGS. 9-13, contemplate the placement of information, including advertising, in areas of the display that remain visible when products are mounted on the display. For example, in the exemplary embodiment of FIGS. 9-13, advertising information is included at 1000A, 1000B, 1000C, and 1000D. The advertising information can be arranged on the display to be associated with a product, for example adjacent a product or on the same mounting/information area as the product. In the exemplary embodiment of FIGS. 9-13, advertising information is provided at location 1000C that is relevant to product 900A, and advertising information is provided at location 1000B that is relevant to product 900B. Other advertising information displayed on the exemplary embodiment of FIG. 9-13 includes the manufacturer's brand name at 1000A and 1000D, and a description of the type of product being displayed at locations 1000B and 1000C. As can be seen, location 1000A is on a general circular area 110 that is mounted on or integral with the column 96 at a top of the display 90. The area 110 is optional and, when provided, can have any shape and size. Various embodiments of the present teachings contemplate mounting a product in the area 110.

In the exemplary embodiment of FIGS. 9-13, products 900A and 900B can be the same product, and as shown here can be displayed in two different views. Product 900A is displayed to show the internal components of the product, whereas product 900B is displayed to show the product as it is used—with its cover on. Other exemplary embodiments of the present teachings, such as those illustrated herein, may similarly display different views of the same product.

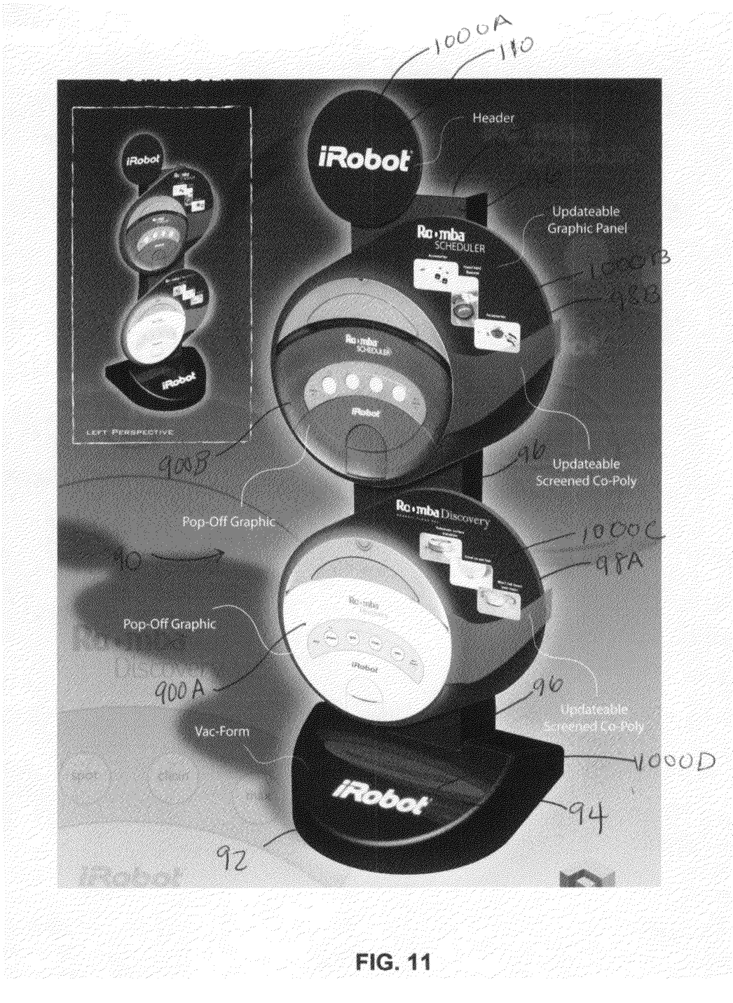

FIG. 11 illustrates the exemplary embodiment of FIGS. 9-13 having a slightly curved and slightly more rounded inclined surface 94. In this illustration of the exemplary embodiment, graphical renderings of the products are included where the products would be mounted, and thus are visible should the product be removed from the display 90 or not mounted on the display 90. The graphical rendering can be applied to the display itself. Alternatively, the graphical rendering can be a removable/interchangeable graphical rendering to be applied to the display when a product is not mounted on the display. Other exemplary embodiments of the present teachings, such as those illustrated herein, may similarly include such graphical renderings. Also in this illustration of the exemplary embodiment, the column 96 is shown to be a U-shaped hollow member.

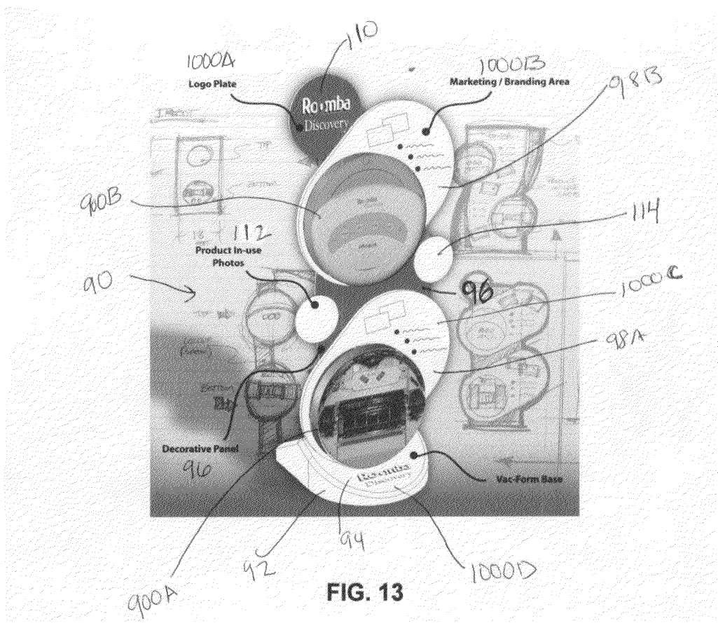

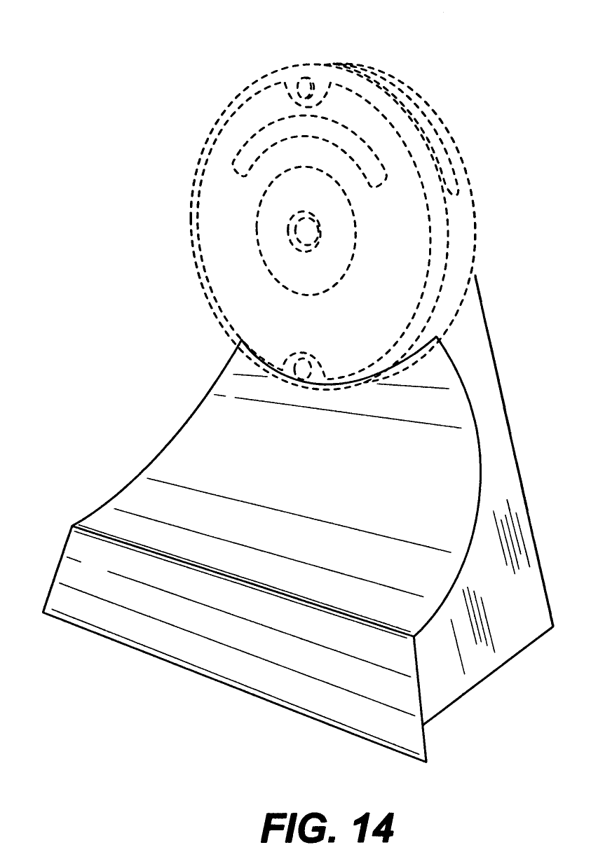

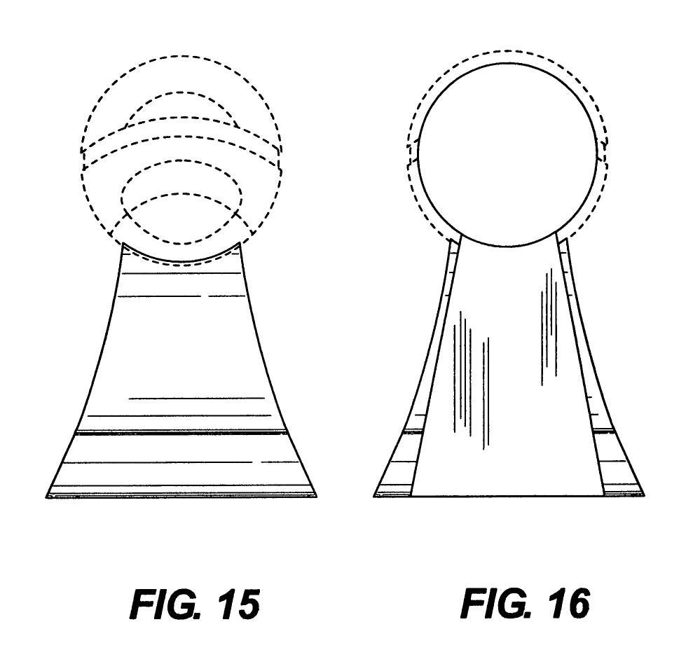

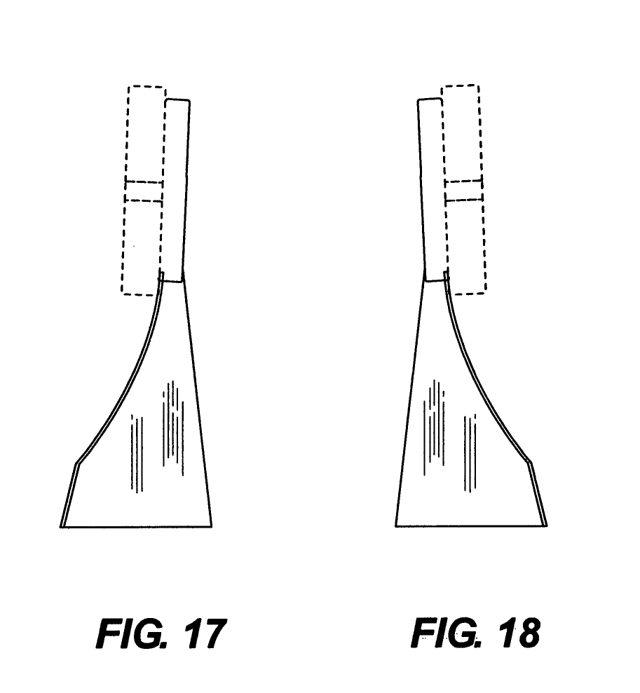

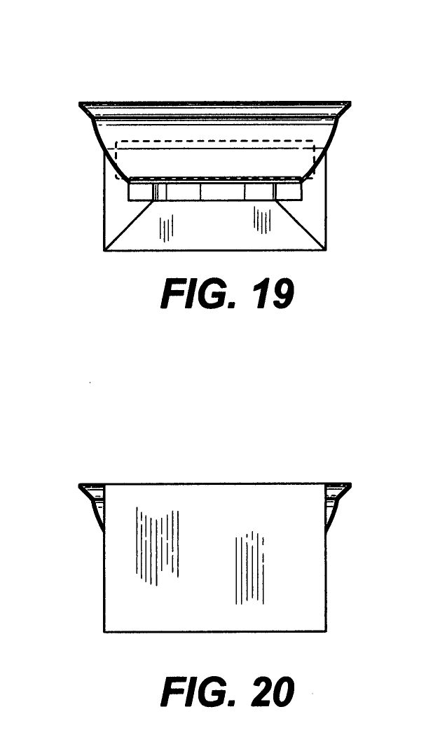

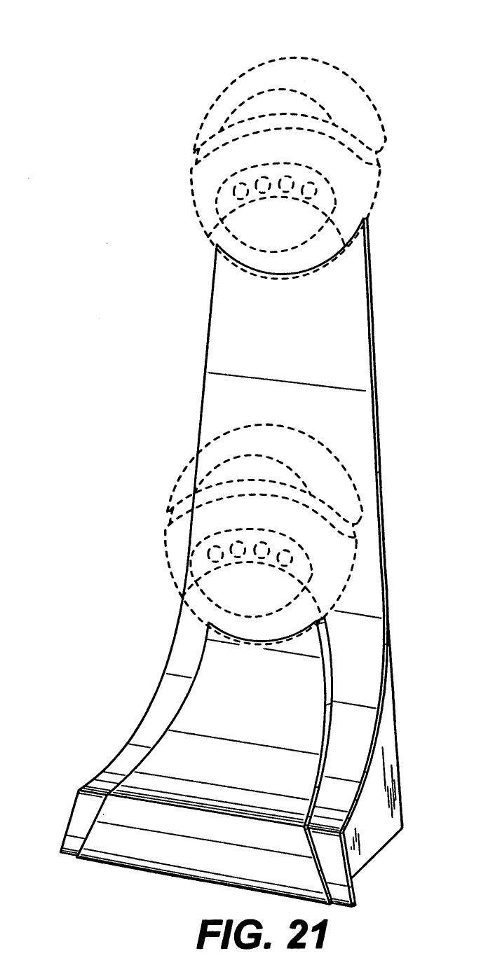

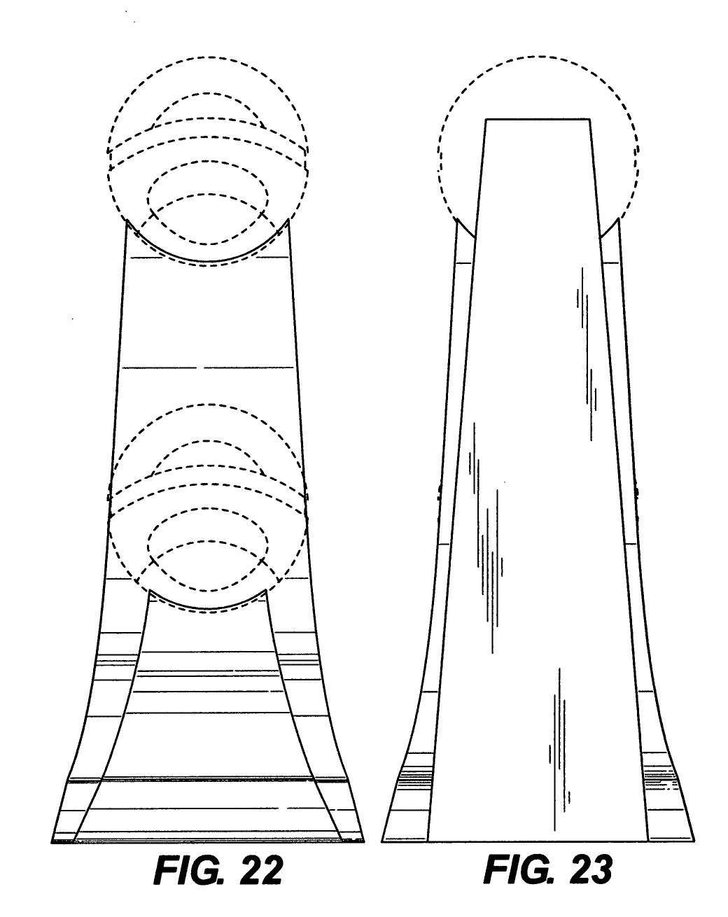

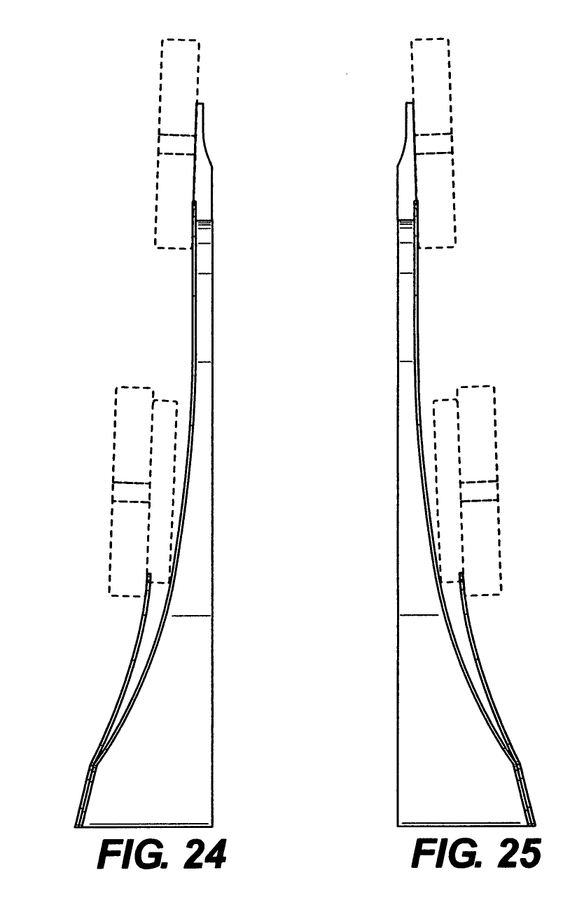

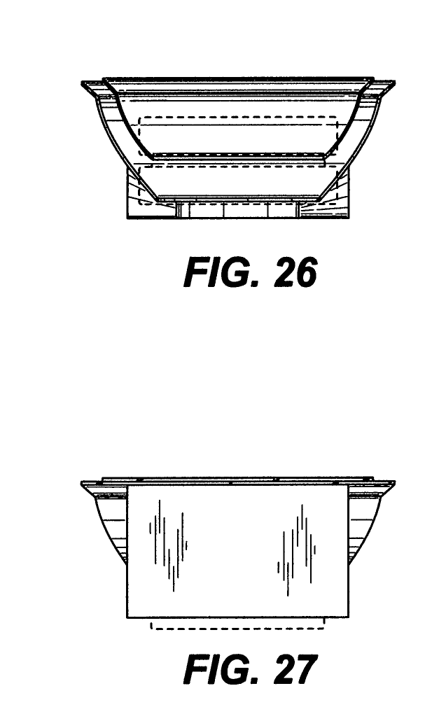

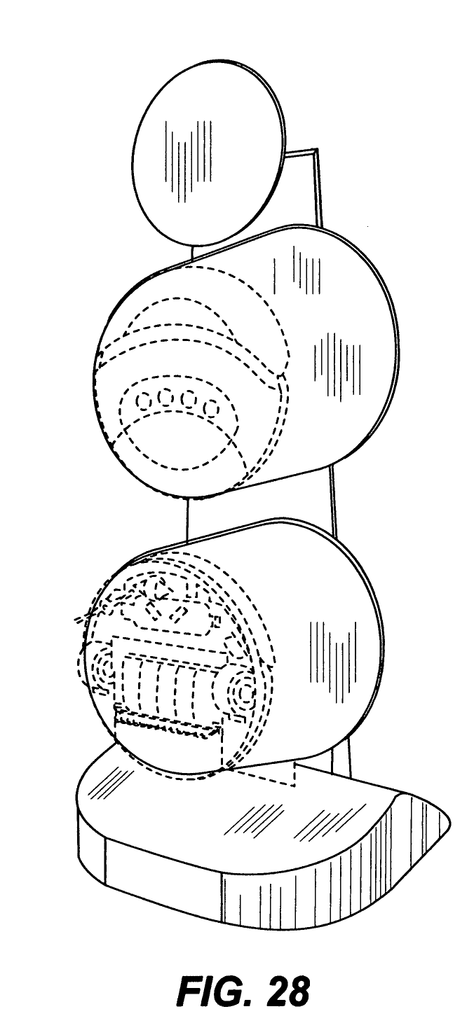

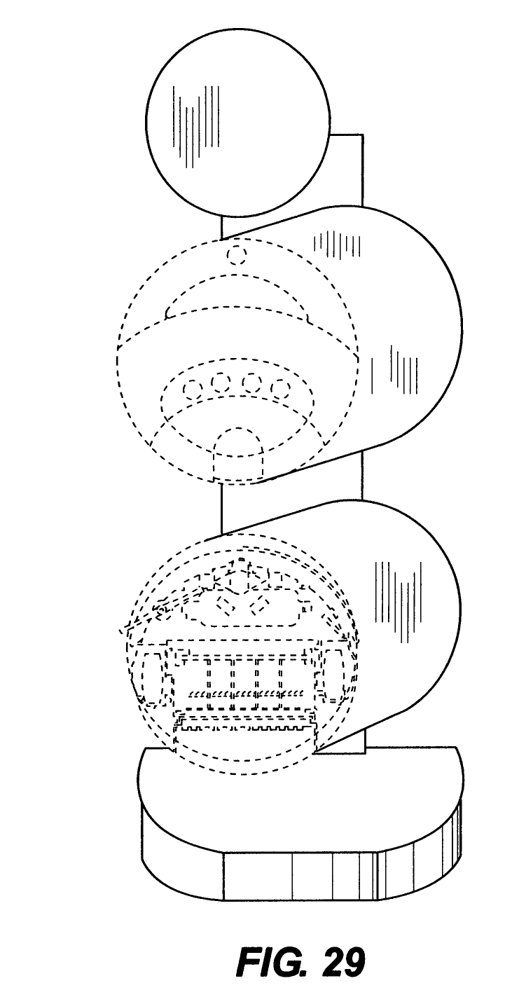

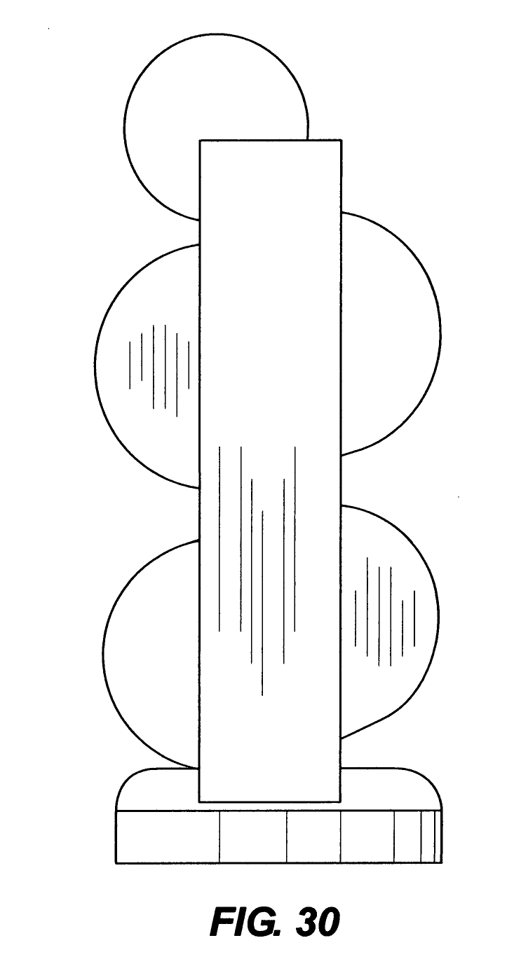

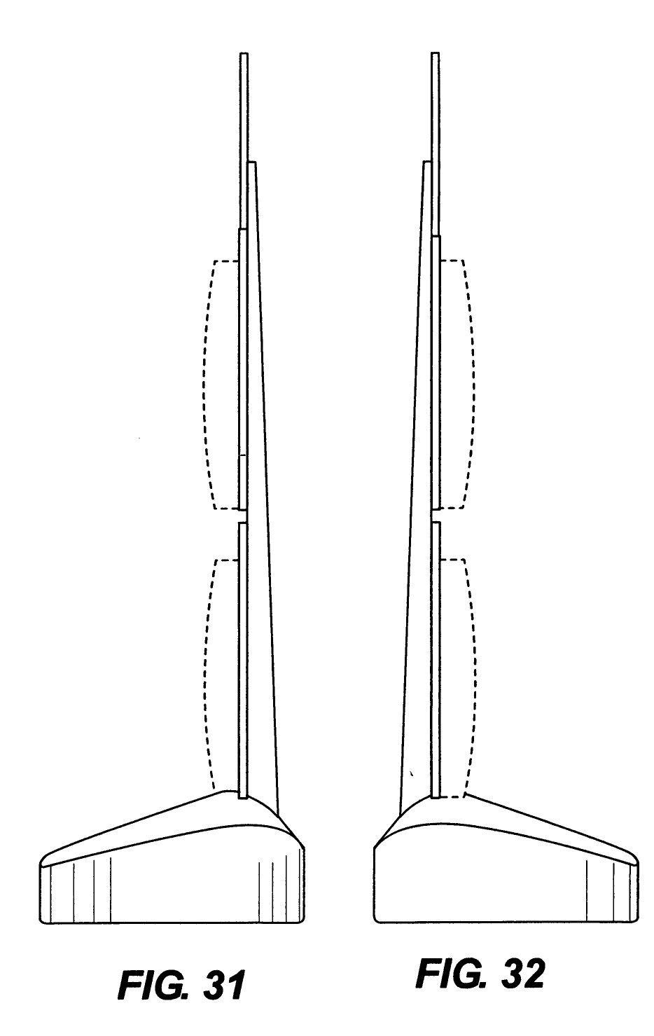

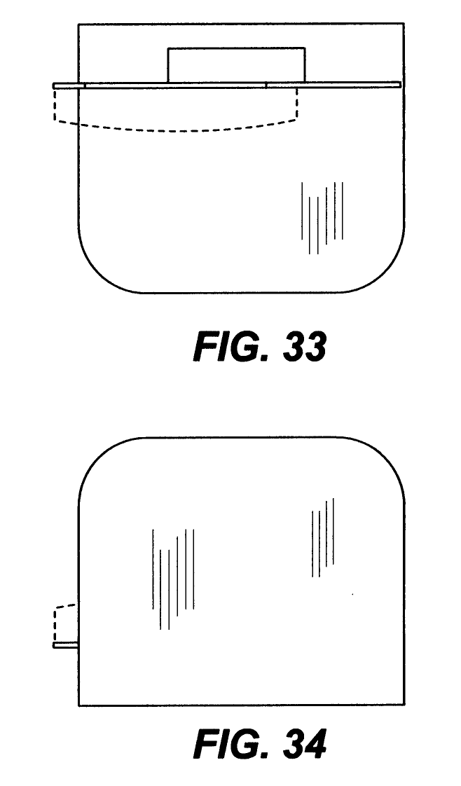

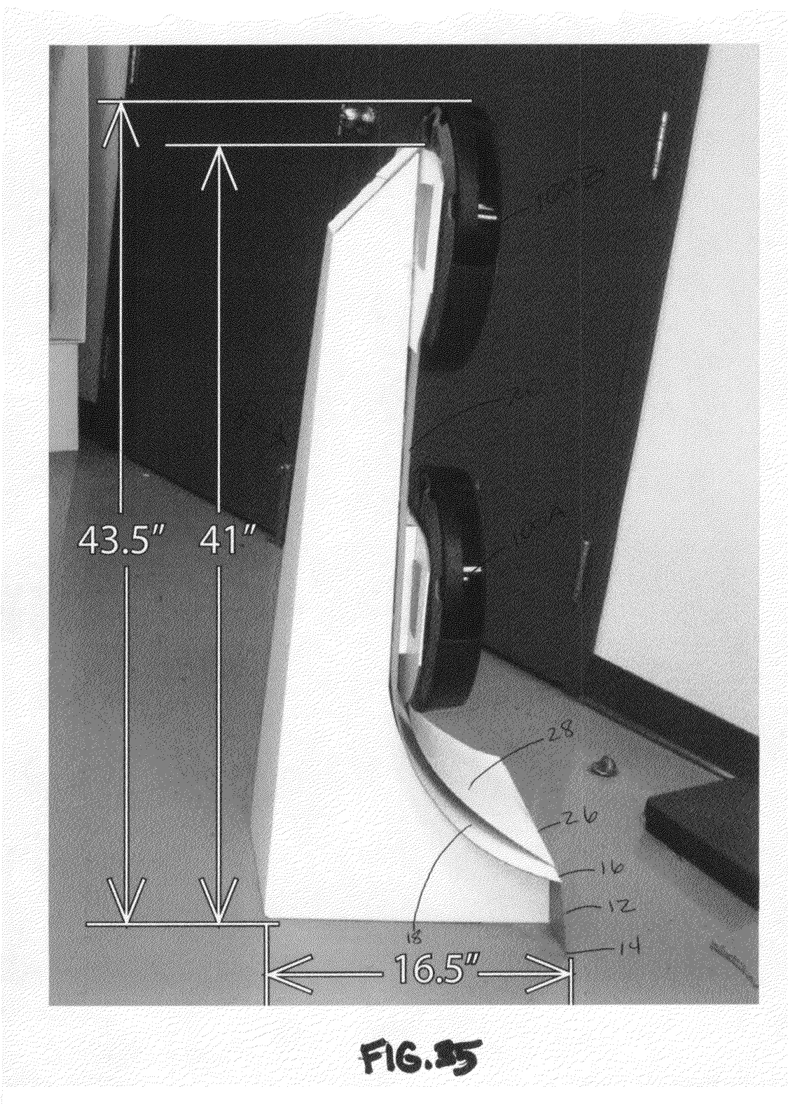

FIG. 13 illustrates the exemplary embodiment of FIGS. 9-13 having a column 96 with thicker, curved sides between the mounting/information areas 98A and 98B. Alternatively, the thicker, curved sides can be mounted on the column 96. Optional generally circular areas 112 and 114 can be provided, in addition to generally circular area 110, which are mounted on or integral with the column 96, for example between the mounting/information areas 98A and 98B. The areas 110, 112, and 114 are optional and, when provided, can have any shape and size. Information, such as product and/or brand information, can be provided in the areas 110, 112, and 114. Various embodiments of the present teachings contemplate mounting a product in the area 110, 112, and 114.

In various embodiments of the present teachings, the display can be made from a suitably strong and economically feasible material, such as cardboard, plastic, or a composite material, metal, etc. The entire display need not comprise the same material. Those skilled in the art will appreciate that a variety of materials are known and commonly used for product displays, and all such materials are contemplated by the present teachings.

While the present invention has been disclosed in terms of preferred embodiments in order to facilitate better understanding of the invention, it should be appreciated that the invention can be embodied in various ways without departing from the principle of the invention. Therefore, the invention should be understood to include all possible embodiments which can be embodied without departing from the principle of the invention set out in the appended claims.

For the purposes of this specification and appended claims, unless otherwise indicated, all numbers expressing quantities, percentages or proportions; and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their-respective testing measurements. Moreover, all ranges disclosed herein are to be understood to encompass any and all subranges subsumed therein.

It is noted that, as used in this specification and the appended claims, the singular forms “a,” “an,” and “the,” include plural referents unless expressly and unequivocally limited to one referent. Thus, for example, reference to “a product” includes two or more different products. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the display of the present disclosure without departing from the scope its teachings. Other embodiments of the disclosure will be apparent to those skilled in the art from consideration of the specification and practice of the teachings disclosed herein. It is intended that the specification and examples be considered as exemplary only.

1. A display having a shape similar to at least a base of an upright vacuum cleaner, the display comprising:
a base configured to rest on a support surface;
a curved section extending upward from the base; and
a mounting area on or extending above the curved section, the mounting area being configured to have a product mounted thereon.

2. The display of claim 1, wherein a front section of the base has a substantially trapezoidal shape.

3. The display of claim 1, wherein a non-curved section extends upward from the curved section to a top edge.

4. The display of claim 3, wherein the curved section and the non-curved section decrease in width as they extend upward.

5. The display of claim 3, comprising two mounting areas configured to have a product mounted thereon, a first mounting area being on or above the curved section and a second mounting area being on or above the non-curved section.

6. The display of claim 5, wherein the mounting areas are vertically spaced from each other.

7. The display of claim 1, wherein information regarding the product can be provided at locations on the display.

8. The display of claim 7, wherein the information is provided on one or more of: on the mounting area, adjacent the mounting area, and on the base.

9. The display of claim 1, further comprising a graphical rendering of the product applied to the display in the mounting area.

10. The display of claim 1, further comprising a removable/interchangeable graphical rendering mounted or otherwise adhered to the display in the mounting area.

11. A display having a base with a shape similar to a base of an upright vacuum cleaner, the display comprising:
a generally vertical column extending upward from the base; and
a mounting/information area mounted on or integral with the generally vertical column, the mounting/information area being configured to have a product mounted thereon.

12. The display of claim 11, comprising two mounting/information areas configured to have a product mounted thereon, and being mounted on or integral with the generally vertical column.

13. The display of claim 12, wherein the mounting areas are vertically spaced from each other.

14. The display of claim 11, wherein information regarding the product can be provided at locations on the display.

15. The display of claim 14, wherein the information is provided on one or more of the mounting area/information area and the base.

16. The display of claim 11, further comprising a graphical rendering of the product applied to the display in the mounting/information area.

17. The display of claim 11, further comprising a removable/interchangeable graphical rendering mounted or otherwise adhered to the display in the mounting/information area.

18. A method of displaying a product, the method comprising mounting the product or a graphical rendering thereof on a display having a shape similar to at least a base of an upright vacuum cleaner.

19. The method of claim 18, further comprising displaying information regarding the product on at least a portion of the display.

20. The method of claim 18, further comprising situating the display among upright vacuum cleaners when viewed by consumers.
